(19) United States
(12) Patent Application Publication
(10) Pub. No.: US 2015/0293940 A1
(43) Pub. Date: Oct. 15, 2015

(54) IMAGE TAGGING METHOD AND APPARATUS THEREOF

(71) Applicant: Samsung Electronics Co., Ltd., Suwon-si (KR)

(72) Inventors: Yong Hyun Kim, Incheon (KR); Ji Woo Lee, Gyeongsangbuk-do (KR)

(21) Appl. No.: 14/684,251

(22) Filed: Apr. 10, 2015

(30) Foreign Application Priority Data
Apr. 10, 2014 (KR) 10-2014-0042739

(51) Int. Cl. G06F 17/30

(52) U.S. Cl. CPC G06F 17/30253; G06F 17/30477; G06F 17/30528; G06F 17/30864

(57) ABSTRACT

An image tagging method of an electronic device according to certain embodiments of the present disclosure includes transmitting a selected image to a server, receiving, from the server, tag information extracted on the basis of the image, generating information on a tag area on the image on the basis of the tag information, comparing the tag information with a pre-stored tag database to extract connection information matched to the tag information, and tagging the extracted connection information to the tag area.

### CROSS-REFERENCE TO RELATED APPLICATION AND CLAIM OF PRIORITY

The present application is related to and claims priority of Korean patent application No. 10-2014-0042739 filed Apr. 10, 2014, the disclosure of which is hereby incorporated in its entirety by reference, is claimed.

### TECHNICAL FIELD

The present disclosure relates to an image tagging method and device.

### BACKGROUND

As mobile devices such as smartphones are widely used, new services for allowing users to express their opinions or lives on the Internet attract attention. A social network service (SNS) such as Twitter or Facebook, is a representative example of such new services. Smartphone users promote their products or companies' products or share their experiences or pictures through the SNS.

With the development of an image processing technology, a technology for recognizing a human face from an image is used for various electronic devices. By virtue of the face recognition technology, a human face is recognized from an image, and a face desired by a user is extracted from a plurality of pictures using feature points on images. A service not only for recognizing a face on an image but also for searching for data related to the image is provided.

According to typical technologies for recognizing human faces on images, a face recognition success rate is very low if a face on an image is small or unclear, and information is unable to be tagged for a person whose face is not shown on an image.

### SUMMARY

To address the above-discussed deficiencies, it is a primary object to provide an electronic device for improving the convenience of a user by tagging connection information to various tag areas recognized on an image, and an image tagging method thereof.

The technical objects of the present disclosure are not limited to the above-mentioned objects, and other technical objects may be clearly understood by those skilled in the art from the disclosure below.

According to certain embodiments of the present disclosure, an image tagging method of an electronic device includes: transmitting a selected image to a server; receiving, from the server, tag information extracted on the basis of the image; generating information on a tag area on the image on the basis of the tag information; comparing the tag information with a pre-stored tag database to extract connection information matched to the tag information; and tagging the extracted connection information to the tag area.

According to another embodiment of the present disclosure an electronic device includes: an input/output interface configured to allow a user to select an image shared through a sharing program; a communication interface configured to transmit the selected image to a server, and receive, from the server, tag information extracted on the basis of the image and information on a tag area on the image extracted on the basis of the tag information; and a processor configured to compare the tag information with a pre-stored tag database to extract connection information matched to the tag information, and tag the extracted connection information to the tag area.

According to another embodiment of the present disclosure, an image tagging method of an electronic device includes: transmitting, to a server, an image selected by a user from among images shared on a social network service program; receiving, from the server, tag information extracted on the basis of the image and information on a tag area on the image extracted on the basis of the tag information; comparing the tag information with a pre-stored tag database to extract user information of another user having a relation with the user on the social network service program, the user information matched to the tag information; and tagging the extracted user information to the tag area.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a network environment including an electronic device according to various embodiments of the present disclosure;

FIG. 2 illustrates an image tagging method of the electronic device according to various embodiments of the present disclosure;

FIG. 3 illustrates the image tagging method for the case where extracted connection information is plural according to various embodiments of the present disclosure;

FIG. 4 illustrates the image tagging method for the case where connection information is selected by a user according to various embodiments of the present disclosure;

FIG. 5 illustrates a sharing program for implementing the image tagging method of the electronic device according to various embodiments of the present disclosure;

FIG. 6 illustrates an exemplary process for extracting tag information according to the image tagging method of the electronic device according to various embodiments of the present disclosure;

FIG. 7 illustrates an exemplary process for extracting a tag area according to the image tagging method of the electronic device according to various embodiments of the present disclosure;

FIG. 8 illustrates an exemplary process for extracting connection information and tagging the connection information to a tag area according to the image tagging method of the electronic device according to various embodiments of the present disclosure;

FIG. 9 illustrates an example of carrying out the image tagging method of the electronic device according to various embodiments of the present disclosure;

FIG. 10 illustrates an image tagging result of the image tagging method of the electronic device according to various embodiments of the present disclosure;

FIG. 11 illustrates an operation of an image tagging system according to certain embodiments of the present disclosure; and

FIG. 12 illustrates an electronic device according to various embodiments of the present disclosure.

### DETAILED DESCRIPTION

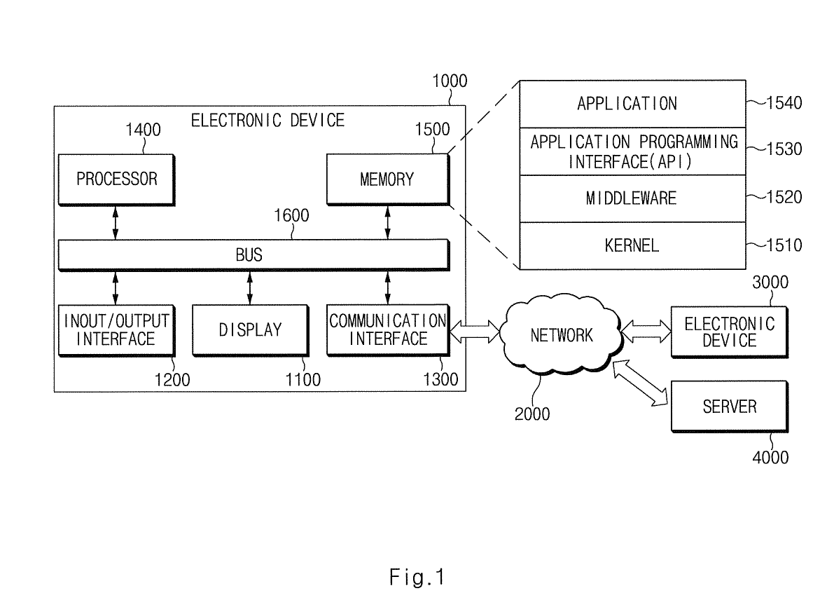

FIGS. 1 through 12, discussed below, and the various embodiments used to describe the principles of the present disclosure in this patent document are by way of illustration only and should not be construed in any way to limit the scope of the disclosure. Those skilled in the art will understand that the principles of the present disclosure be implemented in any suitably arranged wireless communication system. Hereinafter, the present disclosure will be described with reference to the accompanying drawings. The present disclosure may be variously modified and includes various embodiments. However, specific embodiments are exemplarily illustrated in the drawings and detailed descriptions related thereto are provided. However, it should be understood that the particular embodiments are not intended to limit the present disclosure to specific forms, but rather the present disclosure is meant to cover all modifications, similarities, and alternatives which are included in the spirit and scope of the present disclosure. Like reference numerals refer to like elements.

The terms “include,” “comprise,” “including,” or “comprising” used herein indicate disclosed functions, operations, or existence of elements but do not exclude other functions, operations or elements. It will be further understood that the terms “comprises”, “comprising,”, “includes” or “including”, when used herein, specify the presence of stated features, integers, steps, operations, elements, or components, but do not preclude the presence or addition of one or more other features, integers, steps, operations, elements, components, or groups thereof.

The meaning of the term “or” used herein includes any combination of the words connected by the term “or.” For example, the expression “A or B” may indicate A, B, or both A and B.

The terms such as “first,” “second,” and the like used herein refer to various elements of various embodiments, but do not limit the elements. For example, such terms do not limit the order and/or priority of the elements. Furthermore, such terms may be used to distinguish one element from another element. For example, “a first user device” and “a second user device” indicate different user devices. For instance, without departing the scope of the present disclosure, a first element may be named as a second element, and similarly, a second element may be named as a first element.

It will be understood that when an element is referred to as “connected” or “coupled” to another element, it may be directly connected or coupled to the other element or intervening elements may be present. In contrast, when an element is referred to as “directly connected” or “directly coupled” to another element, there are no intervening elements present. Other words used to describe the relationship between elements should be interpreted in a like fashion (such as “between” versus “directly between,” “adjacent” versus “directly adjacent,” etc.).

The terminology used herein is not for delimiting the present disclosure but for describing specific embodiments. The terms of a singular form may include plural forms unless otherwise specified.

The terms used herein, including technical or scientific terms, have the same meanings as understood by those skilled in the art. It is further understood that terms in common usage should also be interpreted as is customary in the relevant art and not in an idealized or overly formal sense unless expressly so defined herein.

An electronic device, according to various embodiments of the present disclosure, includes a communication function. For example, the electronic devices includes at least one of smartphones, tablet personal computers (PCs), mobile phones, video telephones, electronic book readers, desktop PCs, laptop PCs, network computers, personal digital assistants (PDAs), portable multimedia players (PMPs), MP3 players, mobile medical devices, cameras, wearable devices (such as head-mounted-devices (HMDs) such as electronic glasses), electronic apparel, electronic bracelets, electronic necklaces, electronic appcessories, electronic tattoos, and smart watches.

According to various embodiments, electronic devices are smart home appliances having communication functions. The smart home appliances include at least one of, for example, TVs, DVD players, audios, refrigerators, air conditioners, cleaners, ovens, microwave ovens, washing machines, air cleaners, set-top boxes, TV boxes (such as a SAMSUNG HOME SYNC® box, APPLE TV® box, or GOOGLE TV® box), game consoles, electronic dictionaries, electronic keys, camcorders, and electronic picture frames.

According to various embodiments, electronic devices includes at least one of medical devices (such as magnetic resonance angiography (MRA), magnetic resonance imaging (MRI), computed tomography (CT), scanners, and ultrasonic devices), navigation devices, global positioning system (GPS) receivers, event data recorders (EDRs), flight data recorders (FDRs), vehicle infotainment devices, electronic equipment for vessels (such as navigation systems and gyrocompasses), avionics, security devices, head units for vehicles, industrial or home robots, automatic teller's machines (ATMs), and points of sales (POSs).

According to various embodiments, electronic devices include at least one of parts of furniture or buildings or structures having communication functions, electronic boards, electronic signature receiving devices, projectors, and measuring instruments (such as water meters, electricity meters, gas meters, and wave meters). Electronic devices, according to various embodiments of the present disclosure, are one or more combinations of the above-mentioned devices. Furthermore, electronic devices, according to various embodiments of the present disclosure, are flexible devices. In addition, it would be obvious to those skilled in the art that electronic devices according to the present disclosure are not limited to the above-mentioned devices.

Hereinafter, electronic devices according to various embodiments are described with reference to the accompanying drawings. The term “user” used herein may refer to a person who uses an electronic device or may refer to a device (such as an artificial electronic device) that uses an electronic device.

The present disclosure relates to an image tagging method and device. According to various embodiments of the present disclosure, tag information and a tag area are extracted on the basis of an image selected by a user, and connection information related to the tag information is tagged to the tag area. For example, when the image is shared by a sharing program executed in an electronic device, the user is rapidly and easily connected to other users who are interested in the shared image by selecting the connection information. Hereinafter, the image tagging method and device according to certain embodiments of the present disclosure are described in detail with reference to FIGS. 1-10.

FIG. 1 illustrates a network environment including an electronic device according to various embodiments of the present disclosure.

Referring to FIG. 1, an electronic device 1000, according to certain embodiments of the present disclosure, includes a display 1100, an input/output interface 1200, a communication interface 1300, a processor 1400, a memory 1500, and a bus 1600.

According to certain embodiments, the display 1100 displays various information (such as multimedia data or text data) to a user. The display 1100 outputs information (such as an image) stored in the electronic device 1000 or various information (such as an image) processed in the electronic device 1000. For example, the display 1100 outputs various sharing programs executed in the electronic device 1000 and outputs an image shared by the sharing programs.

The display 1100 includes at least one of a liquid crystal display (LCD), a thin film transistor LCD (TFT LCD), a light emitting diode (LED), an organic LED (OLED), an active matrix OLED (AMOLED), a flexible display, a bended display, and a 3D display. Some of the displays are transparent or light-transmissive displays.

According to certain embodiments, the display 1100 is provided as a touchscreen including a touch panel so as to have a function of the input/output interface 1200. The touch panel transfers a user input responding to a gesture of a user to the processor 1400. In certain embodiments, the user input generated by a touching means such as a finger or a touch pen includes a touch, a multi touch, a tap, a double tap, a long tap, tap & touch, drag, flick, press, pinch in or pinch out.

According to certain embodiments, the input/output interface 1200 transfers a command or data input by the user through an input/output device (such as a sensor, a keyboard or a touchscreen) to the processor 1400, the memory 1500 or the communication interface 1300 through, for example, the bus 1600. For example, the input/output interface 1200 provides, to the processor 1400, data on a touch of the user input through the touchscreen. Furthermore, the input/output interface 1200 outputs, through the input/output device (such as a speaker or a display), the command or data received from the processor 1400, the memory 1500 or the communication interface 1300 through the bus 1600. For example, the input/output interface 1200 outputs voice data processed by the processor 1400 to the user through a speaker.

According to certain embodiments, the input/output interface 1200 receives a selection command from the user with respect to an image output through the display 1100. For example, the input/output interface 1200 receives the selection command for the image from the user through a touch or a contactless proximity touch. The contactless proximity touch is construed as a technique for performing a function according to a gesture of the user by detecting the approach of a touch of the user even though the user does not touch a screen of the display 1100 and referred to as “hovering.” For example, the input/output interface 1200 receives the selection command for the image from the user by recognizing a gaze of the user. For example, the input/output interface 1200 includes, for example, at least one of a keypad, a dome switch, a touchpad (resistive or capacitive type), a jog wheel, and a jog switch. Furthermore, the input/output interface 1200 includes a voice recognition module for recognizing a voice of the user to select an image. In various embodiments described below, the input/output interface 1200 is regarded as a touchpad and a touchscreen of the input/output interface 1200 is enabled through the touch panel of the display 1100.

According to certain embodiments, the communication interface 1300 establishes communication between the electronic device 1000 and an external device (such as an electronic device 3000 or a server 4000). For example, the communication interface 1300 is connected to a network 2000 through wireless or wired communication so as to communicate with the external device. The wireless communication includes at least one of wireless fidelity (Wi-Fi) communication, BLUETOOTH (BT) communication, near field communication (NFC), global positioning system (GPS) or cellular communication (such as LTE, LTE-A, CDMA, WCDMA, UMTS, WiBro, or GSM). The wired communication includes at least one of universal serial bus (USB) communication, high definition multimedia interface (HDMI) communication, recommended standard 232 (RS-232) communication, and plain old telephone service (POTS) communication.

According to certain embodiments, the network 2000 is a telecommunications network and includes at least one of a computer network, the Internet, the Internet of things, and a telephone network. According to certain embodiments, a protocol (such as a transport layer protocol, a data link layer protocol or a physical layer protocol) for communication between the electronic device 1000 and the external device is supported by at least one of an application 1540, an application programming interface 1530, a middleware 1520, a kernel 1510 and the communication interface 1300.

According to certain embodiments, the server 4000 supports an operation of the electronic device 1000 by performing at least one of operations (or functions) implemented in the electronic device 1000.

According to certain embodiments, the communication interface 1300 transfers an image selected by the user to the server 4000. The communication interface 1300 receives, from the server 4000, tag information extracted on the basis of the transferred image and information on a tag area on the image extracted on the basis of the tag information.

According to certain embodiments, the information on the tag area is also extracted by the processor 1400 of the electronic device 1000, and the processor 1400 identifies object areas by analyzing the selected image. For example, the information on the tag area is extracted on the basis of the tag information transferred through the communication interface 1300, a relation between the identified object areas, or at least one piece of information.

According to certain embodiments, the processor 1400 receives a command from another element (such as the memory 1500, the input/output interface 1200, the display 1100, or the communication interface 1300) through the bus 1600, interprets the received command, and performs an operation or data processing according to the interpreted command.

According to certain embodiments, the processor 1400 compares the tag information transferred through the communication interface 1300 with a tag database stored in the memory 1500 so as to extract connection information matched to the tag information. The tag database represents data stored in such a manner that the connection information is differentiated for each category. The category includes various items such as persons, things and places. For example, when the image selected through the input/output interface 1200 is shared through an SNS application, the connection information includes a profile image or user information of a user related to a specific category.

The processor 1400 tags the extracted connection information to the tag area. According to certain embodiments, the processor 1400 outputs the extracted connection information to a preset location on the tag area. When the connection information output to the display 1100 is selected by the user, the processor 1400 establishes a connection to a homepage of the user or a specific webpage corresponding to the connection information. For example, when the connection information is selected by the user, the processor 1400 requests a webpage corresponding to the connection information from a server. The webpage received from the server is output through the display 1100.

According to certain embodiments, the memory 1500 stores a command or data received from or generated by the processor 1400 or another element (such as the input/output interface 1200, the display 1100, or the communication interface 1300).

According to certain embodiments, the memory 1500 stores the image or tag database selected by the user. The memory 1500 includes programming modules such as the kernel 1510, the middleware 1520, the application programming interface (API) 1530, or the application 1540. Each programming module includes software, firmware, hardware, or a combination of at least two thereof.

The kernel 1510 controls or manages system resources (such as the bus 1600, the processor 1400 or the memory 1500) used to perform an operation or function of another programming module, for example, the middleware 1520, the API 1530 or the application 1540. Furthermore, the kernel 1510 provides an interface for allowing the middleware 1520, the API 1530 or the application 1530 to access individual elements of the electronic device 1000 in order to control or manage the elements.

The middleware 1520 serves as an intermediary so that the API 1530 or application 1540 communicates and exchanges data with the kernel 1510. Furthermore, the middleware 1520 performs a control operation (such as scheduling or load balancing) with respect to operation requests received from the application 1540 by assigning a priority for using system resources (such as the bus 1600, the processor 1400 or the memory 1500) of the electronic device 1000 to at least one application 1540.

The API 1530, an interface for allowing the application 1540 to control a function provided by the kernel 1510 or middleware 1520, includes at least one interface or function (such as a command) for, for example, file control, window control, image processing, or character control.

According to various embodiments, the application 1540 includes an SMS/MMS application, an electronic mail application, a calendar application, an alarm application, a health care application (such as an application for measuring an amount of exercise or blood sugar), or an environment information application (such as an application for providing atmospheric pressure, humidity or temperature information). In various embodiments, the application 1540 is an application related to information exchange between the electronic device 1000 and the external electronic device (such as the electronic device 3000). The application related to information exchange includes, for example, a notification relay application for transferring specific information to the external electronic device or a device management application for managing the external electronic device.

For example, the notification relay application includes a function of transferring notification information generated by another application (such as an SMS/MMS application, an electronic mail application, a health care application or an environment information application) to the external electronic device (such as the electronic device 3000). In various embodiments, the notification relay application receives notification information from the external electronic device (such as the electronic device 3000) and provides the notification information to the user. The device management application manages (such as install, uninstall or update) a function (such as turning on or off an external electronic device or a component thereof, or adjusting brightness or resolution of a display) of at least a part of the external device (such as the electronic device 3000), an application running in the external electronic device, or a service (such as a call service or a messaging service) provided from the external electronic device.

According to various embodiments, the application 1540 includes a designated application according to an attribute (such as the type of an electronic device) of the external electronic device (such as the electronic device 3000). For example, when the external electronic device is an MP3 player, the application 1540 is related to the playback of music. Similarly, when the external electronic device is a mobile medical device, the application 1540 is related to health care. According to certain embodiments, the application 1540 includes at least one of an application designated for the electronic device 1000 and an application received from the external electronic device (such as the server 4000 or the electronic device 3000).

The bus 1600 is a circuit for connecting the above-mentioned elements to each other and for communication (such as control message transfer) between the above-mentioned elements.

According to certain embodiments, the server 4000 analyzes an image transferred from the electronic device 1000 using various image processing methods. The server 4000 extracts the tag information on the basis of pieces of text information obtained as a result of retrieval of data related to the image (such as result of image retrieval). For example, the tag information includes at least one piece of information of which an occurrence frequency (such as a reference value indicating the number of times of occurrence of the same text as a result of retrieval) is higher than a preset reference value, among the obtained pieces of text information.

According to certain embodiments, the server 4000 extracts information on the tag area on an image on the basis of the tag information. In detail, the server 4000 analyzes the image transferred from the electronic device 1000 so as to differentiate object areas (such as a human face, a thing and a background) on the image. The tag area is extracted by analyzing a relation between the differentiated object areas and the tag information.

The electronic device 1000, according to various embodiments of the present disclosure, extracts the tag information and the tag area based on the image selected by the user. The connection information related to the tag information is tagged to the tag area. For example, when the image is shared through a sharing program executed in the electronic device, the user is rapidly and easily connected to other users who are interested in the shared image by selecting the connection information.

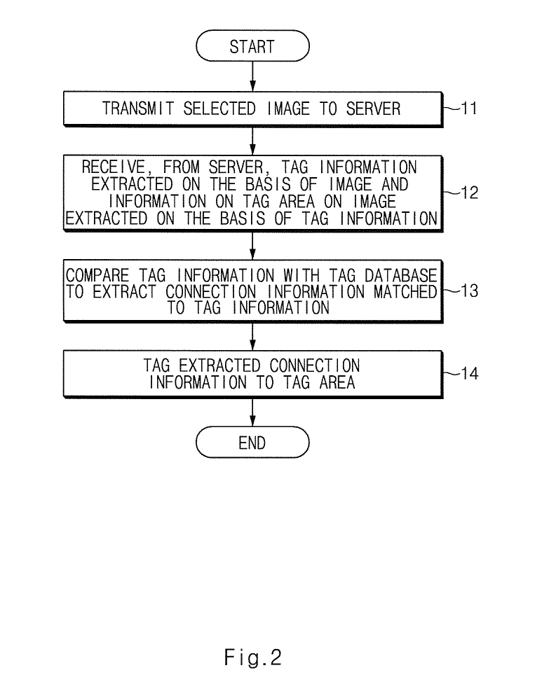

FIG. 2 illustrates an image tagging method of an electronic device according to various embodiments of the present disclosure.

Referring to FIG. 2, the image tagging method of the electronic device, according to various embodiments of the present disclosure, includes: transmitting a selected image to a server; receiving, from the server, tag information extracted on the basis of the image and information on a tag area on the image extracted on the basis of the tag information; comparing the tag information with a tag database to extract connection information matched to the tag information; and tagging the extracted connection information to the tag area. Operations 11-14 are described in detail with reference to FIG. 1.

In operation 11, the communication interface 1300 transfers the image selected by the user to a server.

In operation 12, the communication interface 1300 receives, from the server, the tag information extracted on the basis of the image and the information on the tag area on the image extracted on the basis of the tag information. The tag information or the information on the tag area is the same as the tag information or the information on the tag area described above with reference to FIG. 1. According to certain embodiments, the information on the tag area is internally generated in the electronic device 1000 on the basis of the tag information transferred from the server 4000.

In operation 13, the processor 1400 compares the tag information transferred through the communication interface 1300 with the tag database stored in the memory 1500 so as to extract the connection information matched to the tag information.

In operation 14, the processor 1400 tags the extracted connection information to the tag area. For example, the processor 1400 tags the extracted connection information to a predetermined location on the tag area.

An image tagging method of an electronic device, according to various embodiments of the present disclosure, includes: transmitting a selected image to a server; receiving, from the server, tag information extracted on the basis of the image and information on a tag area on the image extracted on the basis of the tag information; comparing the tag information with a pre-stored tag database to extract connection information matched to the tag information; and tagging the extracted connection information to the tag area.

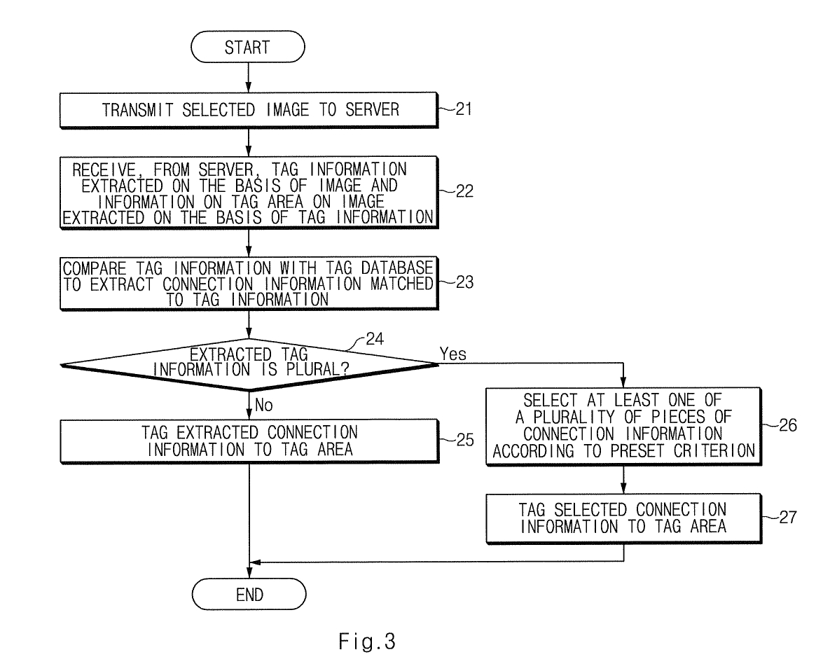

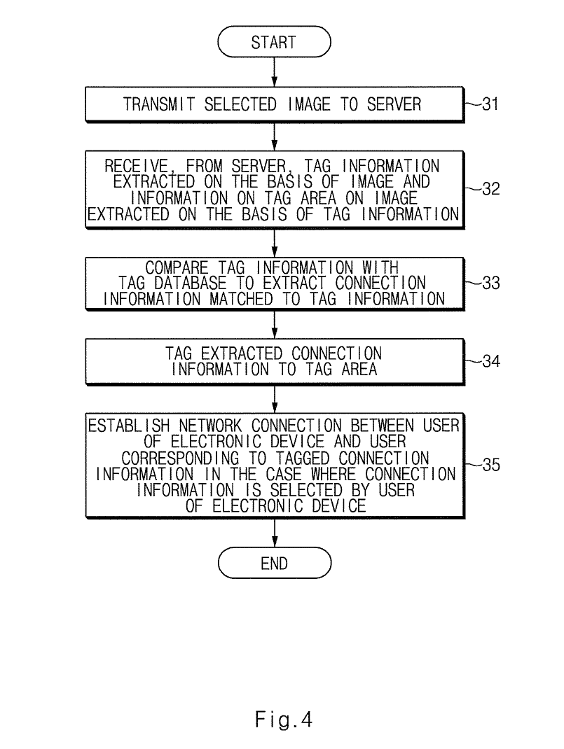

FIGS. 3 and 4 are flowcharts illustrating an image tagging method of an electronic device according to various embodiments of the present disclosure. FIG. 3 illustrates various embodiments in which the extracted connection information is plural, and FIG. 4 illustrates various embodiments in which the connection information is selected by a user.

Referring to FIG. 3, the image tagging method of the electronic device according to another embodiment of the present disclosure includes: transmitting a selected image to a server; receiving, from the server, tag information extracted on the basis of the image and information on a tag area on the image extracted on the basis of the tag information; comparing the tag information with a tag database to extract connection information matched to the tag information; determining whether the extracted connection information is plural; and tagging the extracted connection information to the tag area if the extracted connection information is not plural. When the extracted connection information is plural as a result of the determination, the method further includes: selecting at least one of a plurality of pieces of connection information according to a preset criterion; and tagging the selected connection information to the tag area. Operations 21-27 are described in detail with reference to FIG. 1.

In certain embodiments, operations 21-23 are the same as operations 11 to 13 described above with reference to FIG. 2. Operation 25 is the same as operation 14, and detailed descriptions thereof are omitted to avoid redundant descriptions.

In operation 24, the processor 1400 determines whether the extracted connection information is plural.

In operation 26, the processor 1400 selects at least one of the plurality of pieces of connection information according to the criterion. For example, the processor 1400 selects from among the plurality of pieces of connection information as much as a set number according to an extraction order. For example, the processor 1400 selects from among the plurality of pieces of connection information of a user highly related to a user of the electronic device 1000 as much as a preset number on a sharing program (such as an SNS application). For example, the processor 1400 analyzes log data for a sharing program of the user of the electronic device 1000 so as to select at least one of the plurality of pieces of connection information.

According various embodiments of the present disclosure, at least one of a plurality of pieces of connection information matched to tag information is tagged to a tag area.

Referring to FIG. 4, the image tagging method of the electronic device, according to certain embodiments of the present disclosure, includes: transmitting a selected image to a server; receiving, from the server, tag information extracted on the basis of the image and information on a tag area on the image extracted on the basis of the tag information; comparing the tag information with a tag database to extract connection information matched to the tag information; tagging the extracted connection information to the tag area; and establishing a network connection between a user of the electronic device and a user corresponding to the tagged connection information when the connection information is selected by the user of the electronic device. Operations 31-35 are described in detail with reference to FIG. 1. In certain embodiments, operations 31-34 are the same as operations 11 to 14 described above with reference to FIG. 2, and thus, detailed descriptions thereof are omitted to avoid redundant descriptions.

In operation 35, when the connection information is selected by a user, the processor 1400 establishes a network connection between the user of the electronic device 1000 and a user corresponding to the connection information. For example, when the connection information is selected by the user, the processor 1400 requests a webpage corresponding to the connection information from a server. The webpage received from the server is output through the display 1100. The webpage is, for example, a homepage of the user corresponding to the connection information. According various embodiments of the present disclosure, a user is rapidly and easily connected to another user by selecting the connection information.

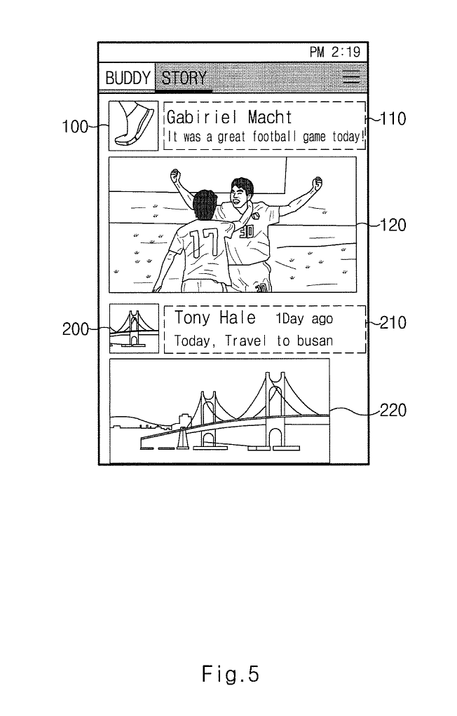

FIGS. 5-10 illustrate specific examples of carrying out the image tagging method of the electronic device according to various embodiments of the present disclosure.

In certain embodiments, when the image tagging method of the electronic device is performed on an image shared through an SNS application. However, this assumption is made merely to help in understanding the present disclosure, and thus, the present disclosure should not be construed as limited to the assumption.

Users who have subscribed to the SNS application share various data. For example, the users upload images stored in their electronic devices to the SNS application to share the images with other users or post messages to share the messages with other users. The users create user information for introducing themselves to open the user information to other users, and set up profile images. Furthermore, the users make comments on images or posted messages shared by other users.

FIG. 5 illustrates a sharing program for implementing the image tagging method of the electronic device according to various embodiments of the present disclosure.

As illustrated in FIG. 5, images shared by users are displayed in the SNS application. For example, a first user (such as Gabriel Macht) and a second user (such as Tony Hale) share images through the SNS application. The first user sets up a profile image 100 and makes a comment 110 (such as “It was a great football game today!”) on an image 120 shared by the first user. Likewise, the second user sets up a profile image 200 and makes a comment 210 (such as “Today, Travel to Busan”) on an image 220 shared by the second user.

The user of the electronic device 1000 checks the images shared by the first and second users using the SNS application. Hereinafter, the user of the electronic device 1000 selects the image 120 shared by the first user.

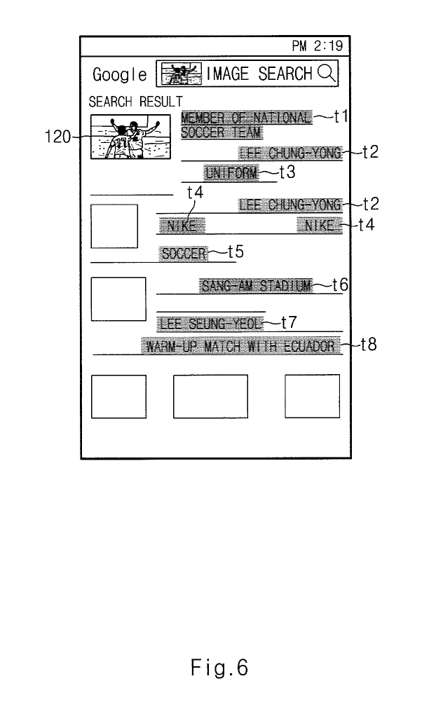

FIG. 6 illustrates an exemplary process for extracting tag information according to the image tagging method of the electronic device according to certain embodiments of the present disclosure.

Referring to FIG. 6, the image selected by the user of the electronic device 1000 is transferred to a server. The server searches for data related to the image 120 using various search engines. The search engines include search engines capable of searching for images, such as GOOGLE® search engine, NAVER® search engine and TINEYE® search engine.

The server obtains pieces of text information t1-t8 as a result of searching for the data related to the image 120. Since the image 120 illustrated in FIG. 6 is related to soccer or a soccer player, the server obtains pieces of text information related to soccer. For example, a member of a national soccer team (t1), Lee Chung-Yong (t2), a uniform (t3), Nike (t4), soccer (t5), Sang-am stadium (t6), Lee Seung-Yeol (t7), and warm-up match with Ecuador (t8) are retrieved as the text information.

The server extracts at least one piece of text information of which an occurrence frequency is higher than a reference value, from the pieces of text information t1-t8 as the tag information. For example, the reference value is relatively set among the pieces of text information. For example, as illustrated in FIG. 6, the pieces of text information t2 and t4 have high occurrence frequencies in comparison with the other pieces of text information, and thus are extracted as tag information. The extracted tag information t2 and t4 are transferred to the electronic device 1000.

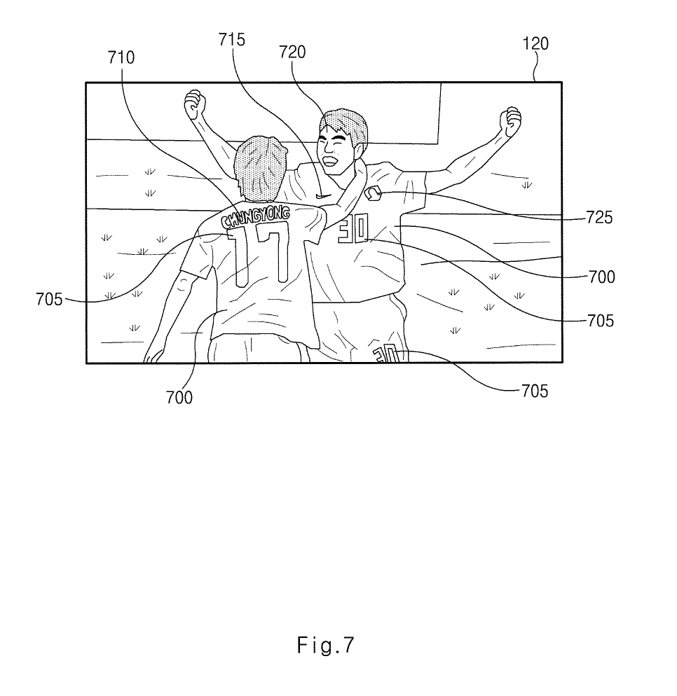

FIG. 7 illustrates an exemplary process for extracting a tag area according to the image tagging method of the electronic device according to various embodiments of the present disclosure.

Referring to FIG. 7, the server analyzes the image 120 using various image analysis methods so as to differentiate object areas. The object areas represent regions that are distinguished by the same feature such as a human face, a body, a thing or a background. For example, clothes, a number, a letter, a brand, a face and a mark on the image 120 are identified as object areas.

The server analyzes relations between the identified object areas and the tag information so as to extract the tag area. For example, the server analyzes relations between the pieces of tag information t2 and t4 and the identified object areas (such as clothes 700, a number 705, a letter 710, a brand 715, a face 720 and a mark 725). For example, the tag information t2 is related to the number 705 “17” and the letter 710 “CHUNGYONG” among the object areas, and the tag information t4 is related to the brand 715 among the object areas. The server extracts regions corresponding to the number 705 “17” and the letter 710 “CHUNGYONG” and a region corresponding to the brand 715 as tag areas.

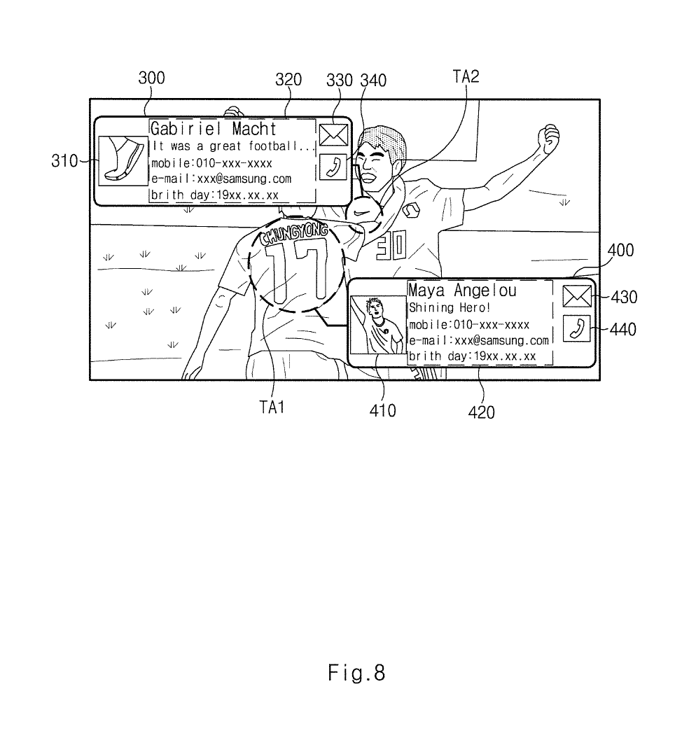

FIG. 8 illustrates an exemplary process for extracting connection information and tagging the connection information to a tag area according to the image tagging method of the electronic device according to various embodiments of the present disclosure.

Referring to FIG. 8, the processor 1400 of the electronic device 1000 compares the tag information t2 and t4 with the tag database stored in the memory 1500 so as to extract connection information 300 and 400 matched to the tag information t2 and t4. The connection information includes profile images 310 and 410 and user information 320 and 420 of users having predetermined relations with the user of the electronic device 1000 on the SNS application.

The tag database represents data stored in such a manner that the connection information is differentiated for each category. In the tag database, the connection information is differentiated for each category such as a person, a brand, a uniform or a nation as stored. For example, in the tag database, according to relations between the profile images of users having predetermined relations with the user of the electronic device 1000 on the SNS application and the categories, the connection information for each user is differentiated as stored. For example, in the tag database, the first user (such as Gabriel Macht) with a profile image of NIKE® shoes is classified as related to the brand category in order as stored. Likewise, in the tag database, a third user (such as Maya Angelou) with a profile image of soccer player Lee Chung-Yong is classified as related to the person category in order as stored.

According to certain embodiments, the processor 1400 compare the tag information t4 transferred from the server with the tag database so as to extract the connection information of the first user, such as the connection information 300. The tag information t4 is matched to the profile image 310 of the first user which has been classified into the brand category as stored.

The connection information 300 includes the profile image 310 and user information 320 of the first user, a message sending tab 330, and a phone connection tab 340. The user information 320 includes, for example, a name, phone number, electronic mail address and birthday of the first user.

According to certain embodiments, the processor 1400 compares the tag information t2 transferred from the server with the tag database so as to extract the connection information of the third user, such as the connection information 400. The tag information t2 is matched to the profile image 410 of the third user which is classified into the person category as stored.

The connection information 400 includes the profile image 410 and user information 420 of the third user, a message sending tab 430, and a phone connection tab 440. The user information 420 includes, for example, a name, phone number, electronic mail address and birthday of the third user.

According to certain embodiments, the processor 1400 tags the connection information 300 and 400 to tag areas TA1 and TA2 on a selected image respectively. For example, when the user of the electronic device 1000 selects the connection information 300, the processor 1400 establishes a network connection to a webpage of the first user. In particular, when the user of the electronic device 1000 selects the message sending tab 330 of the connection information 300, the processor 1400 executes a program for sending a message to the first user. Likewise, when the user of the electronic device 1000 selects the phone connection tab 340 of the connection information 300, the processor 1400 establishes a phone connection to the first user.

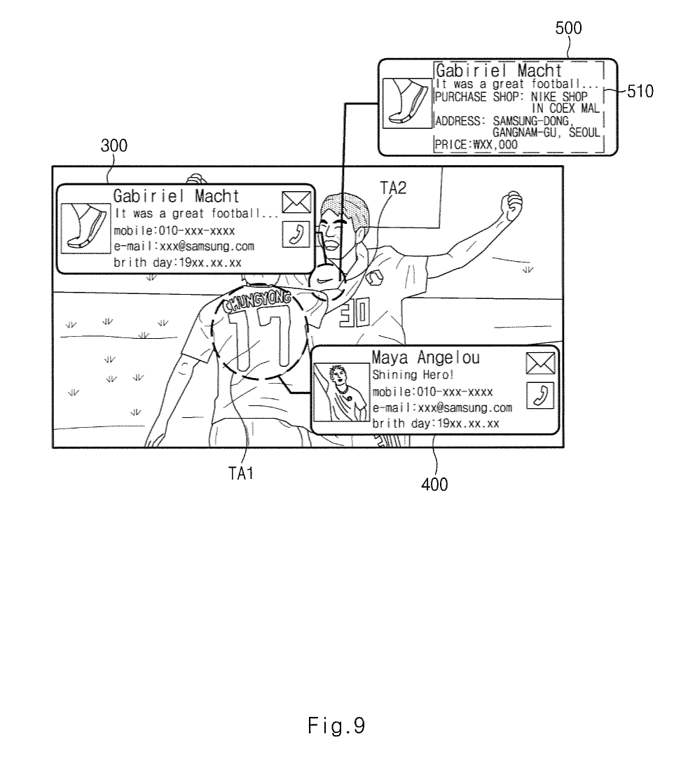

FIG. 9 illustrates another example of carrying out the image tagging method of the electronic device according to various embodiments of the present disclosure.

Referring to FIG. 9, the processor 1400 tag connection information 500, in addition to the connection information 300 and 400, to the tag area TA2. The connection information 500 includes, for example, purchase information 510 of a product of the profile image 310 of the connection information 300 matched to the tag information (such as the tag information t4). When the tag information (such as the tag information t4) is information on a product, the processor 1400 compares the tag information with the tag database so as to tag the matched purchase information 510 to the tag area. Therefore, the user of the electronic device 100 easily obtains the information on the product corresponding to the tag information by checking the purchase information 500.

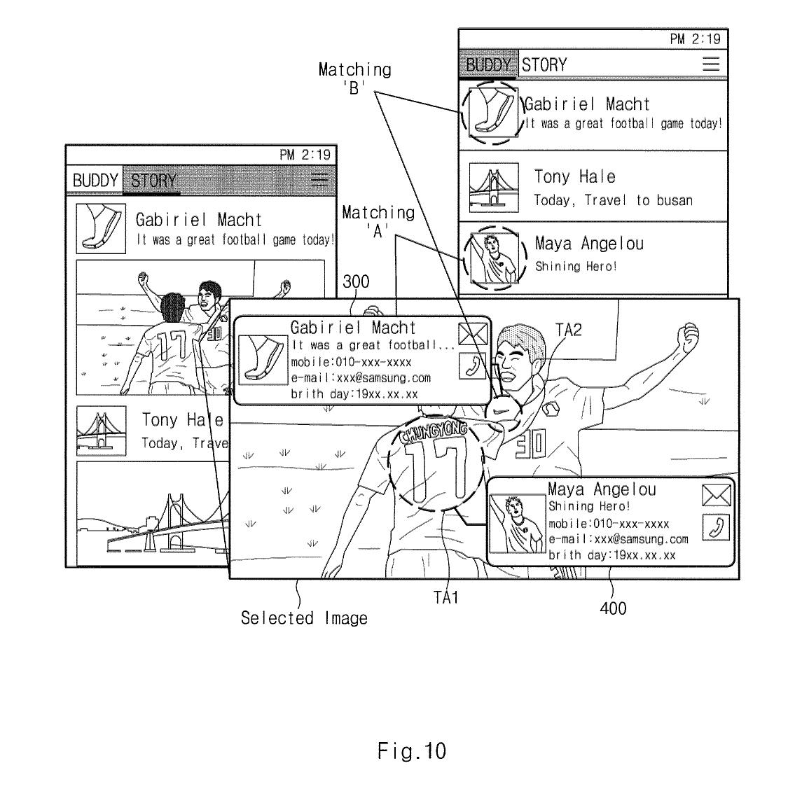

FIG. 10 is a diagram illustrating an image tagging result of the image tagging method of the electronic device according to various embodiments of the present disclosure.

Referring to FIG. 10, the image shared by the first user (such as Gabriel Macht) is selected by the user of the electronic device 1000. The selected image is transferred to the server, and the server extracts the tag information (such as the tag information t2 and the tag information t4) on the basis of the selected image. The server extracts the tag areas TA1 and TA2 on the selected image on the basis of the tag information (such as the tag information t2 and the tag information t4). The server transfers the extracted tag information (such as the tag information t2 and the tag information t4) and tag areas TA1 and TA2 to the electronic device 1000.

The processor 1400 of the electronic device 1000 compares the tag information (such as the tag information t2 and the tag information t4) with the tag database so as to extract the connection information 300 and 400 matched to the tag information. The processor 1400 tags the extracted connection information 300 to the tag area TA2. The connection information 400 is tagged to the tag area TA1.

The user of the electronic device 1000 establishes a network connection to the users (Gabriel Macht and Maya Angelou) having predetermined relations with the user of the electronic device 1000 through the SNS application by using the tagged connection information 300 and 400.

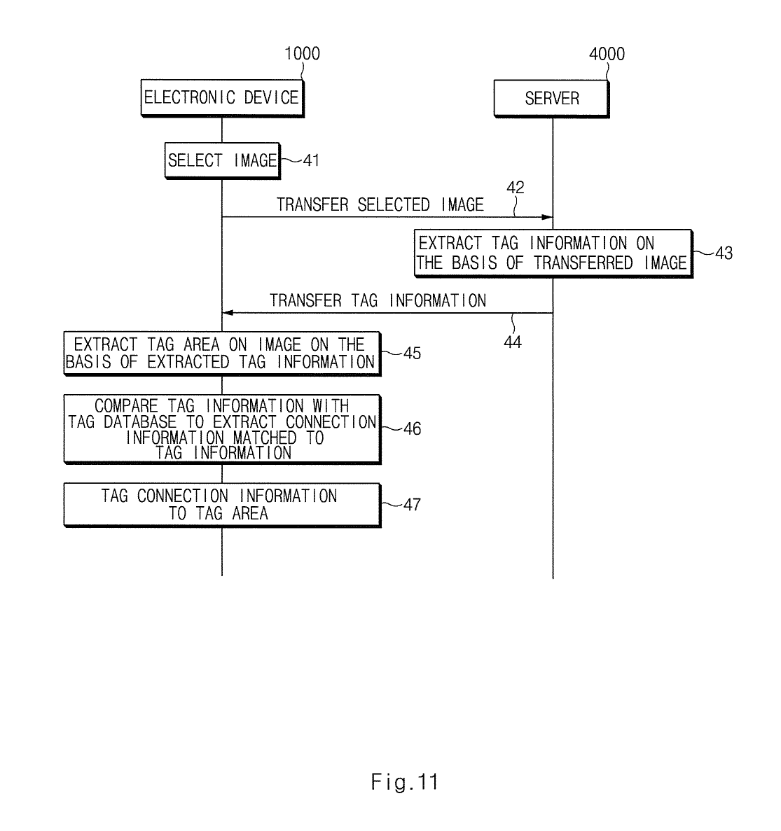

FIG. 11 illustrates an operation of an image tagging system according to various embodiments of the present disclosure.

In operation 41, the electronic device 1000 allows a user to select an image. In operation 42, the electronic device 100 transfers the selected image to the server 4000. In operation 43, the server 400 extracts tag information on the basis of the image. In operation 44, the server 400 transfers the extracted tag information to the electronic device 1000. In operation 45, the server 1000 extracts information on a tag area on the image on the basis of the tag information. In operation 46, the electronic device 100 compares the tag information with the tag database so as to extract connection information matched to the tag information. In operation 47, the electronic device 1000 tags the connection information to the tag area.

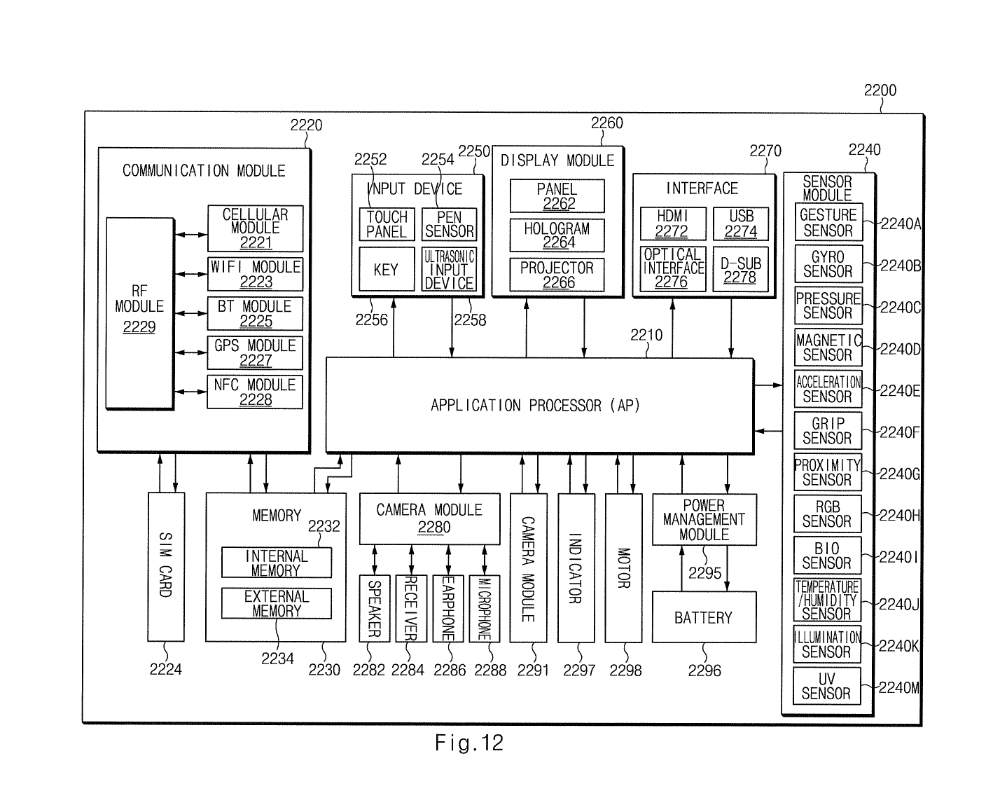

FIG. 12 illustrates an electronic device according to various embodiments of the present disclosure.

Referring to FIG. 12, an electronic device 2200 constitutes, for example, a part or the entirety of the electronic device 1000 illustrated in FIG. 1. The electronic device 2200 includes at least one application processor (AP) 2210, a communication module 2220, a subscriber identification module (SIM) card 2224, a memory 2230, a sensor module 2240, an input device 2250, a display 2260, an interface 2270, an audio module 2280, a camera module 2291, a power management module 2295, a battery 2296, an indicator 2297 and a motor 2298.

The AP 2210 runs an operating system or an application program so as to control a plurality of hardware or software components connected to the AP 2210, and process various data including multimedia data and perform an operation. The AP 2210 is implemented with, for example, a system on chip (SoC). According to certain embodiments, the AP 2210 further includes a graphic processing unit (GPU, not illustrated).

The communication module 2220 (such as the communication interface 1300) performs data transmission or reception for communication between the electronic device 2200 (such as the electronic device 1000) and another electronic device (such as the electronic device 3000 or server 4000) connected thereto through a network. According to certain embodiments, the communication module 2220 includes a cellular module 2221, a Wi-Fi module 2223, a BT module 2225, a GPS module 2227, an NFC module 2228, and a radio frequency (RF) module 2229.

The cellular module 2221 provides a voice call service, a video call service, a text message service, or an Internet service through a telecommunications network (such as LTE, LTE-A, CDMA, WCDMA, UMTS, WiBro or GSM network). Furthermore, the cellular module 2221 identifies and authenticates electronic devices in the telecommunications network using, for example, a subscriber identification module (such as the SIM card 2224). According to certain embodiments, the cellular module 2221 performs at least a part of functions provided by the AP 2210. For example, the cellular module 2221 performs at least a part of a multimedia control function.

According to certain embodiments, the cellular module 2221 includes a communication processor (CP). The cellular module 2221 is implemented with, for example, a SoC. Although FIG. 12 illustrates that the cellular module 2221 (such as a communication processor), the memory 2230 and the power management module 2295 are separate from the AP 2210, the AP 2210 includes at least a part of the foregoing elements (such as the cellular module 2221), according to certain embodiments.

According to certain embodiments, the AP 2210 or the cellular module 2221 (such as a communication processor) loads, on a volatile memory, a command or data received from at least one of a nonvolatile memory and another element connected to the AP 2210 or the cellular module 2221, so as to process the command or data. Furthermore, the AP 2210 or cellular module 2221 stores, in the nonvolatile memory, data received from or generated by at least one of the other elements.

Each of the Wi-Fi module 2223, the BT module 2225, the GPS module 2227 and the NFC module 2228 includes, for example, a processor for processing data transmitted/received through the modules. FIG. 12 illustrates the cellular module 2221, the Wi-Fi module 2223, the BT module 2225, the GPS module 2227 and the NFC module 2228 as if the modules are separate blocks. According to certain embodiments, at least a part (such as two or more) of the cellular module 2221, the Wi-Fi module 2223, the BT module 2225, the GPS module 2227 and the NFC module 2228 are included in a single integrated chip (IC) or IC package. For example, at least a part (such as a communication processor corresponding to the cellular module 2221 and a Wi-Fi processor corresponding to the Wi-Fi module 2223) of the cellular module 2225, the Wi-Fi module 2227, the BT module 2228, the GPS module 2221 and the NFC module 2223 are implemented with a single SoC.

The RF module 2229 transmits or receives data, for example, transmits or receives an RF signal. Although not illustrated, for example, a transceiver, a power amp module (PAM), a frequency filter or a low noise amplifier (LNA) are included in the RF module 2229. Furthermore, the RF module 2229 further includes a component such as a conductor or a wire for transmitting or receiving free-space electromagnetic waves in a wireless communication system. FIG. 12 illustrates the cellular module 2221, the Wi-Fi module 2223, the BT module 2225, the GPS module 2227 and the NFC module 2228 as if the modules share the single RF module 2229. According to certain embodiments, at least one of the cellular module 2221, the Wi-Fi module 2223, the BT module 2225, the GPS module 2227 and the NFC module 2228 transmits or receives RF signals through an additional RF module.

The SIM card 2224 includes a subscriber identification module, and is inserted into a slot formed at a specific location of the electronic device. The SIM card 2224 includes unique identification information (such as an integrated circuit card identifier (ICCID)) or subscriber information (such as international mobile subscriber identity (IMSI)).

The memory 2230 (such as the memory 1500) includes an internal memory 2232 or an external memory 2234. The internal memory 2232 includes at least one of a volatile memory (such as a dynamic RAM (DRAM), a static RAM (SRAM) or a synchronous dynamic RAM (SDRAM)) and a nonvolatile memory (such as a one-time programmable ROM (OTPROM), a programmable ROM (PROM), an erasable and programmable ROM (EPROM), an electrically erasable and programmable ROM (EEPROM), a mask ROM, a flash ROM, a NAND flash memory, or a NOR flash memory).

According to certain embodiments, the internal memory 2232 is a solid state drive (SSD). The external memory 2234 includes a flash drive, for example, compact flash (CF), secure digital (SD), micro secure digital (Micro-SD), mini secure digital (Mini-SD), extreme digital (xD) or a memory stick. The external memory 2234 is functionally connected to the electronic device 2200 through various interfaces. According to certain embodiments, the electronic device 2200 further includes a storage device (or a storage medium) such as a hard drive.

The sensor module 2240 measures physical quantity or detect an operation state of the electronic device 2200 so as to convert measured or detected information into an electrical signal. The sensor module 2240 includes, for example, at least one of a gesture sensor 2240A, a gyro sensor 2240B, a barometer sensor 2240C, a magnetic sensor 2240D, an accelerometer sensor 2240E, a grip sensor 2240F, a proximity sensor 2240G, a color sensor 2240H (such as RGB sensor), a biometric sensor 2240I, a temperature/humidity sensor 2240J, an illuminance sensor 2240K, and an ultraviolet (UV) sensor 2240M. In certain embodiments, the sensor module 2240 includes, for example, an olfactory sensor (E-nose sensor, not illustrated), an electromyography (EMG) sensor (not illustrated), an electroencephalogram (EEG) sensor (not illustrated), an electrocardiogram (ECG) sensor (not illustrated), an infrared (IR) sensor (not illustrated), an iris recognition sensor (not illustrated), or a fingerprint sensor (not illustrated). The sensor module 2240 further includes a control circuit for controlling at least one sensor included therein.

The input device 2250 includes a touch panel 2252, a (digital) pen sensor 2254, a key 2256, or an ultrasonic input device 2258. The touch panel 2252 recognizes a touch input using at least one of capacitive, resistive, infrared and ultraviolet sensing methods. The touch panel 2252 further includes a control circuit. In the case of using the capacitive sensing method, a physical contact recognition or proximity recognition is allowed. The touch panel 2252 further includes a tactile layer. In this case, the touch panel 2252 provides tactile reaction to a user.

The (digital) pen sensor 2254 is implemented in a similar or same manner as the method of receiving a touch input of a user or is implemented using an additional sheet for recognition. The key 2256 includes, for example, a physical button, an optical button, or a keypad. The ultrasonic input device 2258, which is an input device for generating an ultrasonic signal, enables the electronic device 2200 to sense a sound wave through a microphone (such as a microphone 2288) so as to identify data, wherein the ultrasonic input device 2258 is capable of wireless recognition. According to certain embodiments, the electronic device 2200 uses the communication module 2220 so as to receive a user input from an external device (such as a computer or server) connected to the communication module 2220.

The display 2260 (such as the display 1100) includes a panel 2262, a hologram device 2264, or a projector 2265. The panel 2262 is, for example, a liquid crystal display (LCD) or an active-matrix organic light-emitting diode (AM-OLED). The panel 2262 is, for example, flexible, transparent or wearable. The panel 2262 and the touch panel 2252 are integrated into a single module. The hologram device 2264 displays a stereoscopic image in a space using a light interference phenomenon. The projector 2265 project light onto a screen so as to display an image. The screen is arranged in the inside or the outside of the electronic device 2200. According to certain embodiments, the display 2260 further includes a control circuit for controlling the panel 2262, the hologram device 2264, or the projector 2265.

The interface 2270 includes, for example, a high definition multimedia interface (HDMI) 2272, a universal serial bus (USB) 2274, an optical interface 2276, or a D-subminiature 2278. The interface 2270 is included in the communication interface 1300 illustrated in FIG. 1. Additionally or alternatively, the interface 2270 includes, for example, a mobile high-definition link (MHL) interface, a secure digital (SD) card/multi-media card (MMC) interface, or an infrared data association (IrDA) interface.

The audio module 2280 converts a sound into an electrical signal or vice versa. The audio module 2280 processes sound information input or output through a speaker 2282, a receiver 2284, an earphone 2286, or the microphone 2288.

The camera module 2291 for shooting a still image or a video includes at least one image sensor (such as a front sensor or a rear sensor), a lens (not illustrated), an image signal processor (ISP, not illustrated), or a flash (such as an LED or a xenon lamp, not illustrated).

The power management module 2295 manages power of the electronic device 2200. Although not illustrated, a power management integrated circuit (PMIC), a charger integrated circuit (IC), or a battery or fuel gauge is included in the power management module 2295.

The PMIC is mounted on an integrated circuit or a SoC semiconductor. A charging method is classified into a wired charging method and a wireless charging method. The charger IC charges a battery and prevents introduction of an overvoltage or an overcurrent from a charger. According to certain embodiments, the charger IC includes a charger IC for at least one of the wired charging method and the wireless charging method. The wireless charging method includes, for example, a magnetic resonance method, a magnetic induction method or an electromagnetic method, and include an additional circuit, for example, a coil loop, a resonant circuit, or a rectifier.

The battery gauge measures, for example, a remaining capacity of the battery 2296 and a voltage, current or temperature during charging. The battery 2296 stores or generates electricity, and supplies power to the electronic device 2200 using the stored or generated electricity. The battery 2296 includes, for example, a rechargeable battery or a solar battery.

The indicator 2297 includes a specific state of the electronic device 2200 or a part thereof (such as the AP 801), such as a booting state, a message state, or a charging state. The motor 2298 converts an electrical signal into a mechanical vibration. Although not illustrated, a processing device (such as a GPU) for supporting a mobile TV is included in the electronic device 2200. The processing device for supporting a mobile TV processes media data according to the standards of digital multimedia broadcasting (DMB), digital video broadcasting (DVB) or media flow.

Each of the above-mentioned elements of the electronic device according to the present disclosure may be configured with one or more components, and the names of the elements may be changed according to the type of the electronic device. The electronic device, according to the present disclosure, includes at least one of the above-mentioned elements and some elements may be omitted or other additional elements may be added. Furthermore, some of the elements of the electronic device according to the present disclosure may be combined with each other so as to form one entity, so that the functions of the elements may be performed in the same manner as before the combination.

The term “module” used herein represents, for example, a unit including one or more combinations of hardware, software and firmware. The term “module” may be interchangeably used with the terms “unit,” “logic,” “logical block,” “component” and “circuit.” The “module” may be a minimum unit of an integrated component or may be a part thereof. The “module” may be a minimum unit for performing one or more functions or a part thereof. The “module” may be implemented mechanically or electronically. For example, the “module” according to the present disclosure includes at least one of an application-specific integrated circuit (ASIC) chip, a field-programmable gate array (FPGA), and a programmable-logic device for performing some operations, which are known or will be developed.

According to various embodiments of the present disclosure, at least a part of devices (such as modules or functions thereof) or methods (such as operations) is implemented as instructions stored in a computer-readable storage medium in the form of a programming module. When the instructions are performed by at least one processor (such as the processor 2210), the at least one processor performs functions corresponding to the instructions. The computer-readable storage medium is, for example, the memory 2230. At least a part of the programming module is implemented (such as executed) by the processor 2210. At least a part of the programming module includes, for example, a module, program, routine, sets of instructions, or process for performing at least one function.

The computer-readable storage medium includes a magnetic medium such as a hard disk, a floppy disk and a magnetic tape, an optical medium such as a compact disk read only memory (CD-ROM) and a digital versatile disc (DVD), a magneto-optical medium such as a floptical disk, and a hardware device configured to store and execute program instructions (such as programming module), such as a read only memory (RAM), a random access memory (RAM) and a flash memory. The program instructions include machine language codes made by compilers and high-level language codes that may be executed by computers using interpreters. The above-mentioned hardware is configured to be operated as one or more software modules for performing operations of the present disclosure and vice versa.

The module or programming module according to the present disclosure includes at least one of the above-mentioned elements, or some elements may be omitted or other additional elements may be added. Operations performed by the module, the programming module or the other elements are performed in a sequential, parallel, iterative or heuristic way. Furthermore, some operations are performed in another order or are omitted, or other operations are added.

According to various embodiments of the present disclosure, connection information is tagged to not only a face recognized from an image but also an area of an object such as a thing, thereby improving the accessibility of a user to information.

According to various embodiments of the present disclosure, connection information is tagged to an object area recognized from an image shared through an SNS program so as to provide a network connection to other users who are interested in the shared image.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. An image tagging method of an electronic device, comprising:
transmitting a selected image to a server;
receiving, from the server, tag information extracted on a basis of the image;
generating information for a tag area on the image based on the tag information;
comparing the tag information with a pre-stored tag database to extract connection information corresponding to the tag information; and
tagging the connection information to the tag area.

2. The image tagging method according to claim 1, wherein the tag information is extracted based on pieces of text information obtained as a result of searching for data related to the image.

3. The image tagging method according to claim 2, wherein the tag information includes at least one piece of text information with an occurrence frequency higher than a reference value among the pieces of text information.

4. The image tagging method according to claim 1, wherein the tag area is extracted by analyzing a relation between object areas differentiated on the image and the tag information.

5. The image tagging method according to claim 1, wherein the selected image is shared on a sharing program.

6. The image tagging method according to claim 5, wherein the connection information includes profile images and user information of users having a predetermined relation with a user of the electronic device on the sharing program.

7. The image tagging method according to claim 6, wherein the tag database classifies the connection information for each category to store the connection information.

8. The image tagging method according to claim 7, wherein the user information includes at least one of a name, a nick name, a phone number, an electronic mail address and a birthday.

9. The image tagging method according to claim 1, further comprising establishing a network connection between a user of the electronic device and another user corresponding to the connection information when the tag area is selected by the user of the electronic device.

10. The image tagging method according to claim 1, wherein generating information on a tag area on the image based on the tag information includes receiving the information on the tag area from the server.

11. An electronic device comprising:
an input/output interface configured to allow a user to select an image shared through a sharing program;
a communication interface configured to:
transmit the selected image to a server; and
receive, from the server, tag information extracted on a basis of the image and information on a tag area on the image extracted based on the tag information; and
a processor configured to:
compare the tag information with a pre-stored tag database to extract connection information corresponding to the tag information; and
tag the extracted connection information to the tag area.

12. The electronic device according to claim 11, wherein the tag information is extracted based on pieces of text information obtained as a result of searching for data related to the image.

13. The electronic device according to claim 12, wherein the tag information includes at least one piece of text information with an occurrence frequency higher than a reference value among the pieces of text information.

14. The electronic device according to claim 11, wherein the tag area is extracted by analyzing a relation between object areas differentiated on the image and the tag information.

15. The electronic device according to claim 11, wherein the tag database classifies the connection information for each category so as to store the connection information.

16. The electronic device according to claim 15, wherein the user information includes at least one of a name, a nick name, a phone number, an electronic mail address and a birthday.

17. The electronic device according to claim 11, wherein the processor establishes a network connection between the user of the electronic device and another user corresponding to the user information when the tag area is selected by the user of the electronic device.

18. The electronic device according to claim 11, further comprising a display configured to output the image and the tag area.

19. The electronic device according to claim 11, further comprising a memory configured to store the tag database.

20. An image tagging method of an electronic device, comprising:
transmitting, to a server, an image selected by a user from among images shared on a social network service program;
receiving, from the server, tag information extracted on a basis of the image and information on a tag area on the image extracted based on the tag information;
comparing the tag information with a pre-stored tag database to extract user information of another user having a relation with the user on the social network service program, the user information matched to the tag information; and
tagging the user information to the tag area.
